(19) United States
(12) Patent Application Publication
(10) Pub. No.: US 2011/0236046 A1
(43) Pub. Date: Sep. 29, 2011

(54) IMAGE FORMING APPARATUS

(76) Inventors: Yoshihisa Nakao, Kanagawa (JP); Yoshihiro Enomoto, Kanagawa (JP); Katsuya Takenouchi, Kanagawa (JP); Katsunori Kikuchihara, Kanagawa (JP); Kiyotoshi Kaneyama, Kanagawa (JP); Kenji Suzuki, Kanagawa (JP); Masatoshi Yamada, Kanagawa (JP); Kazuyuki Yagata, Kanagawa (JP)

(21) Appl. No.: 12/951,870

(22) Filed: Nov. 22, 2010

(30) Foreign Application Priority Data
Mar. 26, 2010 (JP) 2010-073497

(51) Int. Cl. G03G 15/00

(52) U.S. Cl. 399/46

(57) ABSTRACT

There is provided an image forming apparatus including: a transfer-receiving member onto which developer images are transferred and superimposed in sequence by switching over plural developing units that develop latent images on a latent image holding body with a developer to form developer images; a primary transfer section that primary transfers the developer image on the latent image holding body onto the transfer-receiving member; a secondary transfer section that secondary transfers the developer image on the transfer-receiving member onto a recording medium; and a selection section that selects a combination of a first process speed for the primary transfer and a second process speed for the secondary transfer according to the number of developing units employed.

### CROSS-REFERENCE TO RELATED APPLICATION

This application is based on and claims priority under 35 USC 119 from Japanese Patent Application No. 2010-073497 filed on Mar. 26, 2010.

### BACKGROUND

### Technical Field

The present invention relates to an image forming apparatus.

### SUMMARY

According to an aspect of the invention, there is provided an image forming apparatus including:

a latent image holding body that holds a latent image;

a charging section that charges a surface of the image holding body;

a light-exposing section that light-exposes the surface of the latent image holding body that has been charged by the charging section and forms a latent image;

plural developing units that are made to face the latent image holding body and develop the latent image on the latent image holding body with a developer to form a developer image;

a transfer-receiving member onto which developer images are transferred and superimposed in sequence by switching over the plurality of developing units;

a primary transfer section that primary transfers the developer image on the latent image holding body onto the transfer-receiving member;

a secondary transfer section that secondary transfers the developer image on the transfer-receiving member onto a recording medium; and

a selection section that selects a combination of a first process speed from charging the latent image holding body to the primary transfer and a second process speed from the primary transfer to the secondary transfer according to the number of developing units employed.

### BRIEF DESCRIPTION OF THE DRAWINGS

Exemplary embodiments of the present invention will be described in detail based on the following figures, wherein:

FIG. 1 is an overall schematic diagram of an image forming apparatus according to a first exemplary embodiment of the present invention;

FIG. 2 is a diagram of a configuration of an image forming section according to the first exemplary embodiment of the present invention;

FIG. 3 is a perspective view of a cleaning device according to the first exemplary embodiment of the present invention;

FIG. 4A and FIG. 4B are schematic diagrams showing states of an intermediate transfer belt during 4 color image forming in an image forming apparatus according to the first exemplary embodiment of the present invention;

FIG. 5A and FIG. 5B are schematic diagrams showing states of an intermediate transfer belt during 6 color image forming in an image forming apparatus according to the first exemplary embodiment of the present invention; and

FIG. 6A and FIG. 6B are schematic diagrams showing states of an intermediate transfer belt during 6 color image forming in an image forming apparatus according to a second exemplary embodiment of the present invention.

### DETAILED DESCRIPTION

Explanation follows regarding an example of an image forming apparatus according to a first exemplary embodiment of the present invention.

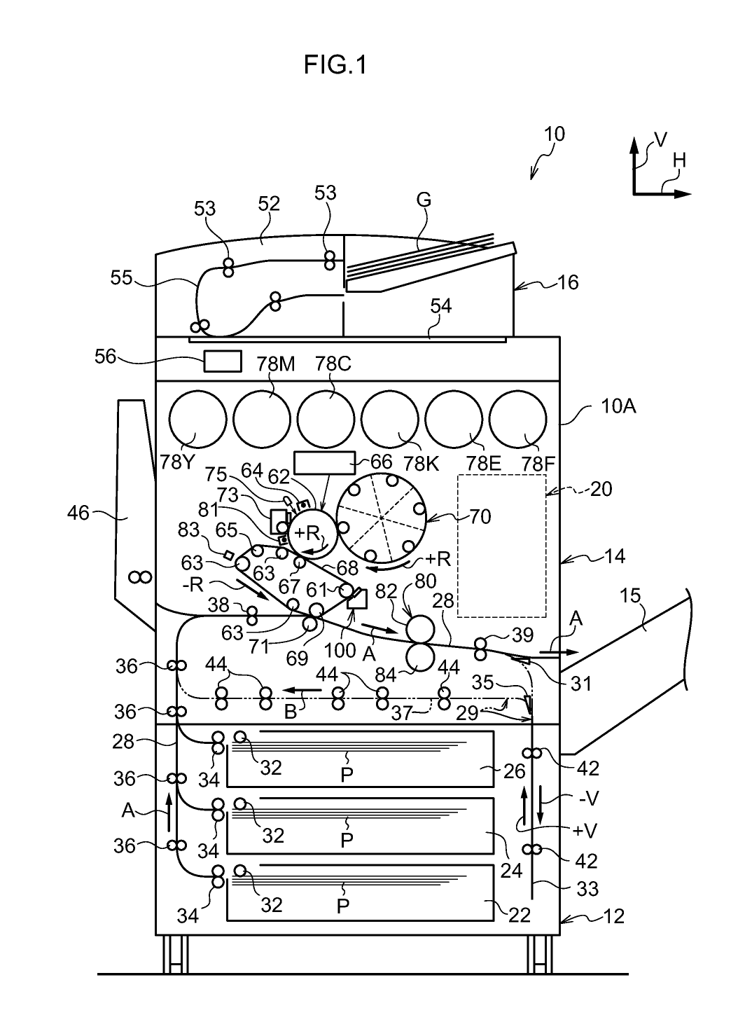

FIG. 1 shows an image forming apparatus 10 as an example of a first exemplary embodiment. The image forming apparatus 10 is configured including, from the bottom towards the top in the vertical direction (direction of arrow V): a paper housing section 12 that houses recording paper P; a image forming section 14 provided above the paper housing section 12 and performing image forming on the recording paper P supplied from the paper housing section 12; an original scanning section 16 provided above the image forming section 14 for scanning an scanning original G; and a control section 20, serving as an example of a selection section that selects either a first process speed or a second process speed, described below, provided in the image forming section 14 and controlling operation of each section of the image forming apparatus 10. In the following explanation, the vertical direction of an apparatus main body 10A of the image forming apparatus 10 is referred to as the arrow V direction, and the horizontal direction is referred to as the arrow H direction.

The paper housing section 12 is provided with a first housing section 22, a second housing section 24, and a third housing section 26 housing different sizes of recording paper P, serving as examples of a recording medium. Feed rolls 32 are provided in the first housing section 22, the second housing section 24, and the third housing section 26, respectively for feeding out the housed recording paper P to a conveying path 28 provided within the image forming apparatus 10. Pairs of conveying rolls 34 and conveying rolls 36 are provided at the downstream side of the feed rolls 32 on the conveying path 28, for conveying the recording paper P one sheet at a time. Positioning rolls 38 are provided on the conveying path 28 downstream of the conveying rolls 36 in the recording paper P conveying direction, for temporarily stopping the recording paper P and feeding the recording paper P out to a secondary transfer position QB, described below, at a particular timing.

The upstream portion of the conveying path 28, as viewed from the front face of the image forming apparatus 10, is provided in a straight line along the arrow V direction from the left hand side of the paper housing section 12 to a left hand side lower portion of the image forming section 14. The downstream portion of the conveying path 28 is provided from the left hand side lower portion of the image forming section 14 up to a paper discharge section 15 provided at the right hand face of the image forming section 14. A double-sided conveying path 29 is connected to the conveying path 28, for conveying and reversing the recording paper P in order to perform image forming on both sides of the recording paper P.

The double-sided conveying path 29 has, when viewed from the front face of the image forming apparatus 10: a first switching member 31 that switches between the conveying path 28 and the double-sided conveying path 29; a reversing section 33 provided in a straight line along the arrow V direction from a right hand side lower portion of the image forming section 14 to the right hand side of the paper housing section 12; a conveying section 37 that conveys the recording paper P in the arrow H direction so that the trailing edge of the recording paper P conveyed into the reversing section 33 is leading; and a second switching member 35 that switches between the reversing section 33 and the conveying section 37. Plural pairs of conveying rolls 42 are provided at intervals in the reversing section 33 and plural pairs of conveying rolls 44 are provided in the conveying section 37.

The first switching member 31 is a triangular pillar shaped member configured so as to switch the conveying direction of the recording paper P by the leading end portion of the first switching member 31 being moved by a drive unit, not shown in the drawings, between one or other of the conveying path 28 or the double-sided conveying path 29. Similarly, the second switching member 35 is a triangular pillar shaped member as viewed from the front face, configured so as to switch the conveying direction of the recording paper P by the leading end portion of the second switching member 35 being moved by a drive unit, not shown in the drawings, between one or other of the reversing section 33 or the conveying section 37. The downstream end portion of the conveying section 37 is connected by a guide member, not shown in the drawings, to a position just in front of the conveying rolls 36 on the upstream portion of the conveying path 28. A fold-up manual paper feed section 46 is also provided to the left hand face of the image forming section 14, and the manual paper feed section 46 is connected to the conveying path 28 just in front of the positioning rolls 38.

The original scanning section 16 is provided with: an original conveying device 52 that automatically conveys a scan original G one sheet at a time; a platen glass 54, disposed downstream of the original conveying device 52 and on which a single sheet scan original G is placed; and an original scanning device 56 that scans the scan original G conveyed by the original conveying device 52 or the scan original G placed on the platen glass 54. The original conveying device 52 has an automatic conveying path 55 on which plural pairs of conveying rolls 53 are disposed, and a portion of the automatic conveying path 55 is disposed such that the scan original G passes across the platen glass 54. The original scanning device 56 scans in a stationary state at the left hand end portion of the platen glass 54 the scan original G that has been conveyed by the original conveying device 52, or scans in the scan original G that has been placed on the platen glass 54 while moving in the arrow H direction.

The image forming section 14 is provided with a circular cylinder shaped photoreceptor 62, serving as an example of a latent image holding body, at a central portion of the apparatus main body 10A. The photoreceptor 62 is configured so as to rotated in the arrow +R direction (the clockwise direction in the drawing) by driving with a drive section, not shown in the drawings, and to hold an electrostatic latent image formed by illuminating light thereon. A corotron charging member 64 is provided at a position above the photoreceptor 62 and facing the outer peripheral face of the photoreceptor 62, for charging the surface of the photoreceptor 62.

A light-exposing device 66 is provided at a position downstream of the charging member 64 in the photoreceptor 62 rotation direction and facing the outer peripheral face of the photoreceptor 62. The light-exposing device 66 includes a semiconductor laser, a f-O lens, a polygon mirror, an imaging lens, and plural mirrors, not shown in the drawings. The light-exposing device 66 is configured to form an electrostatic latent image by deflection-scanning with a polygon mirror a laser beam emitted from the semiconductor laser based on an image signal, and to illuminate (expose) the outer peripheral face of the photoreceptor 62 that has been charged by the charging member 64. Note that the light-exposing device 66 is not limited to the method of scanning a laser beam using a polygon mirror, and, for example, a Light Emitting Diodes (LED) method may be employed.

A developing device 70 is provided downstream in the photoreceptor 62 rotation direction of the illumination position of exposure light from the light-exposing device 66. The developing device 70 is a rotation-switch-over device that develops an electrostatic latent image formed on the outer peripheral face of the photoreceptor 62 with a given color of toner and makes the electrostatic latent image visible. Details regarding the developing device 70 are described below.

An intermediate transfer belt 68, serving as an example of a transfer-receiving member, is provided further downstream than the developing device 70 in the photoreceptor 62 rotation direction and below the photoreceptor 62. The toner image formed on the outer peripheral face of the photoreceptor 62 is transferred onto the intermediate transfer belt 68. The intermediate transfer belt 68 is of an endless shape entrained around a drive roll 61 that is rotationally driven by a control section 20, a tension imparting roll 65 that imparts tension to the intermediate transfer belt 68, plural conveying rolls 63 that make contact with the reverse face of the intermediate transfer belt 68 and perform following rotation, and an auxiliary roll 69 that makes contact with the reverse face of the intermediate transfer belt 68 at the secondary transfer position QB, described later, and performs rotation following the intermediate transfer belt 68. The intermediate transfer belt 68 is configured so as to undertake circulating motion in the arrow −R direction (the anticlockwise direction in the drawing) by rotating the drive roll 61.

A primary transfer roll 67, serving as an example of a primary transfer section, is provided at the opposite side of the intermediate transfer belt 68 to that of the photoreceptor 62, with the intermediate transfer belt 68 disposed therebetween. The primary transfer roll 67 primary transfers the toner image formed on the outer peripheral face of the photoreceptor 62 onto the intermediate transfer belt 68. At a position separated to the downstream side in the intermediate transfer belt 68 movement direction from the position at which the photoreceptor 62 makes contact with the intermediate transfer belt 68 (this is referred to as the primary transfer position QA), the primary transfer roll 67 makes contact with the reverse face of the intermediate transfer belt 68. The primary transfer roll 67 has electrical continuity with a power source, not shown in the drawings, and accordingly, due to the potential difference therefrom to the earthed photoreceptor 62, the toner image on the photoreceptor 62 is primary transferred onto the intermediate transfer belt 68.

A secondary transfer roll 71, serving as an example of a secondary transfer section, is provided at the opposite side of the intermediate transfer belt 68 to that of the auxiliary roll 69, with the intermediate transfer belt 68 disposed therebetween. The secondary transfer roll 71 secondary transfers onto the recording paper P the toner image that has been primary transferred onto the intermediate transfer belt 68. The secondary transfer position QB is present between the secondary transfer roll 71 and the auxiliary roll 69, where the toner image is transferred onto the recording paper P. The secondary transfer roll 71 makes contact with the front face of the intermediate transfer belt 68. The secondary transfer roll 71 is earthed, and the toner image on the intermediate transfer belt 68 is secondary transferred onto the recording paper P by the potential difference between the auxiliary roll 69 that has electrical continuity with (power supplied) from a power source, not shown in the drawings, and the secondary transfer roll 71.

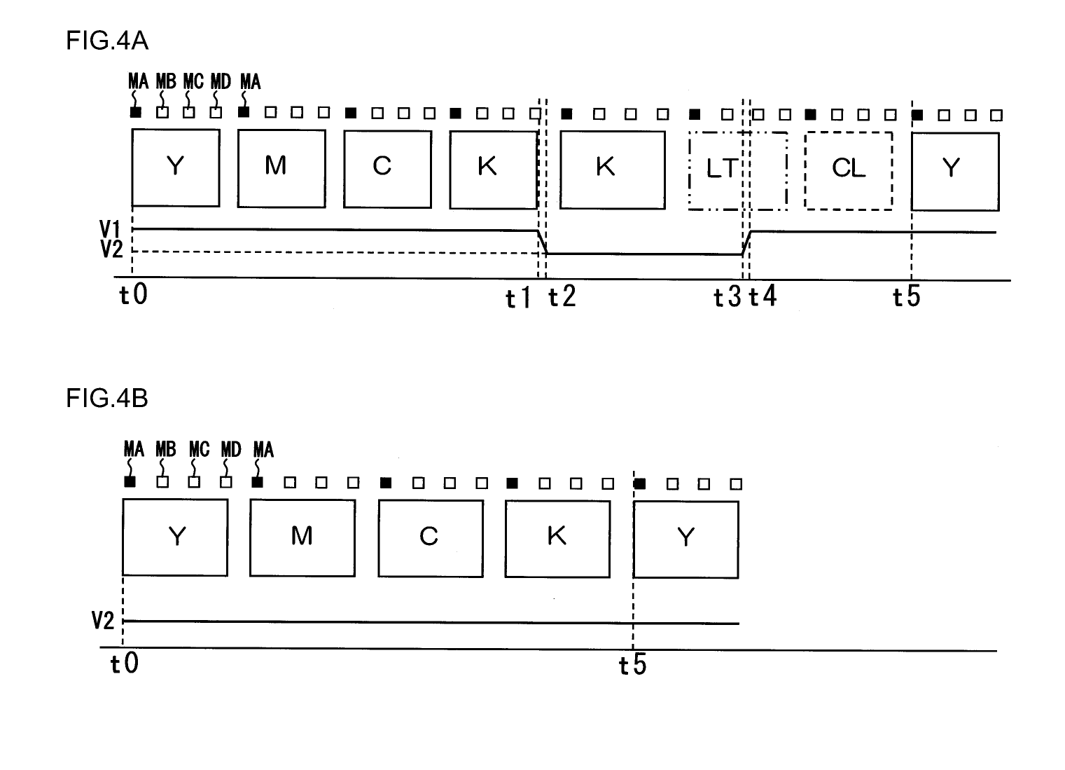

A cleaning device 100 is provided at the opposite side of the intermediate transfer belt 68 to that of the drive roll 61, with the intermediate transfer belt 68 disposed therebetween. The cleaning device 100 recovers toner remaining on the intermediate transfer belt 68 after secondary transfer. Details regarding the cleaning device 100 are described below. A position detection sensor 83 is provided at the periphery of the intermediate transfer belt 68, at a position facing one of the conveying rolls 63. The position detection sensor 83 detects a predetermined reference position on the intermediate transfer belt 68 by detecting marks MA, MB, MC, MD that have been applied to the front face of the intermediate transfer belt 68 (see, for example, FIG. 4A), and outputs a position detection signal upon which a start timing of image forming processing is based.

The marks MA, MB, MC, MD are configured as squares with a reflective material on the surface, with all of them formed the same size as each other. The movement position of the intermediate transfer belt 68 is detected by light emitted from the position detection sensor 83 being reflected by the surface of one or other of the marks MA, MB, MC, MD. In the present exemplary embodiment, the marks MA, MB, MC, MD are provided at uniform intervals in the peripheral direction of the intermediate transfer belt 68, with the mark MA shown for reference as a black square, and the marks MB, MC, MD distinguished by being shown as white squares.

A cleaning device 73 is provided further downstream than the primary transfer roll 67 in the photoreceptor 62 rotation direction. The cleaning device 73 cleans toner and the like remaining on the surface of the photoreceptor 62 that has not been primary transferred onto the intermediate transfer belt 68. The cleaning device 73 is configured to recover remaining toner and the like with a cleaning blade that makes contact with the surface of the photoreceptor 62 and a brush roll. A corotron 81 is provided upstream of the cleaning device 73 in the photoreceptor 62 rotation direction (further downstream than the primary transfer roll 67). The corotron 81 performs electrical discharge of the toner that has remained on the outer peripheral face of the photoreceptor 62 after primary transfer. An electrical discharge device 75 is provided downstream of the cleaning device 73 in the photoreceptor 62 rotation direction (further upstream than the charging member 64). The electrical discharge device 75 illuminates light onto the outer peripheral face of the photoreceptor 62 to perform electrical discharge.

The secondary transfer position QB of the toner images is set by the secondary transfer roll 71 at an intermediate position along the above conveying path 28. A fixing device 80 is provided on the conveying path 28 downstream of the secondary transfer roll 71 in the recording paper P conveying direction (arrow A direction in the drawing). The fixing device 80 fixes the toner image that has been transferred onto the recording paper P by the secondary transfer roll 71. The fixing device 80 is configured with: a heating roll 82, disposed on the toner image face side (topside) of the recording paper P and including a heat source that dissipates heat on electrical conduction; and a press roll 84 disposed below the heating roll 82 and pressing the recording paper P towards the outer peripheral face of the heating roll 82. Conveying rolls 39 are provided on the conveying path 28 further downstream in the recording paper P conveying direction than the fixing device 80, for conveying the recording paper P towards a discharge section 15 or the reversing section 33.

Toner cartridges 78Y, 78M, 78C, 78K, 78E, 78F containing each of the toners, respectively yellow (Y), magenta (M), cyan (C), black (K), first spot color (E) and second spot color (F), are exchangeably provided next to each other in a horizontal row below the original scanning device 56 and above the developing device 70. The first spot color E and the second spot color F are selected, or not selected, from spot colors (including transparent) other than yellow, magenta, cyan and black. Configuration is made such that 6-color Y, M, C, K, E, F image formation is performed in the developing device 70 when the first spot color E and the second spot color F have been selected, and 4-color Y, M, C, K image formation is performed when the first spot color E and the second spot color F have not been selected. Note that in the present exemplary embodiment, as an example, explanation is given of image forming with 4-colors Y, M, C, K, or with 6-colors Y, M, C, K, E, F however, as another example, configuration may be made such that image forming is with 5-colors, these being the 4-color Y, M, C, K plus either the first spot color E or the second spot color F.

Explanation now follows regarding the developing device 70.

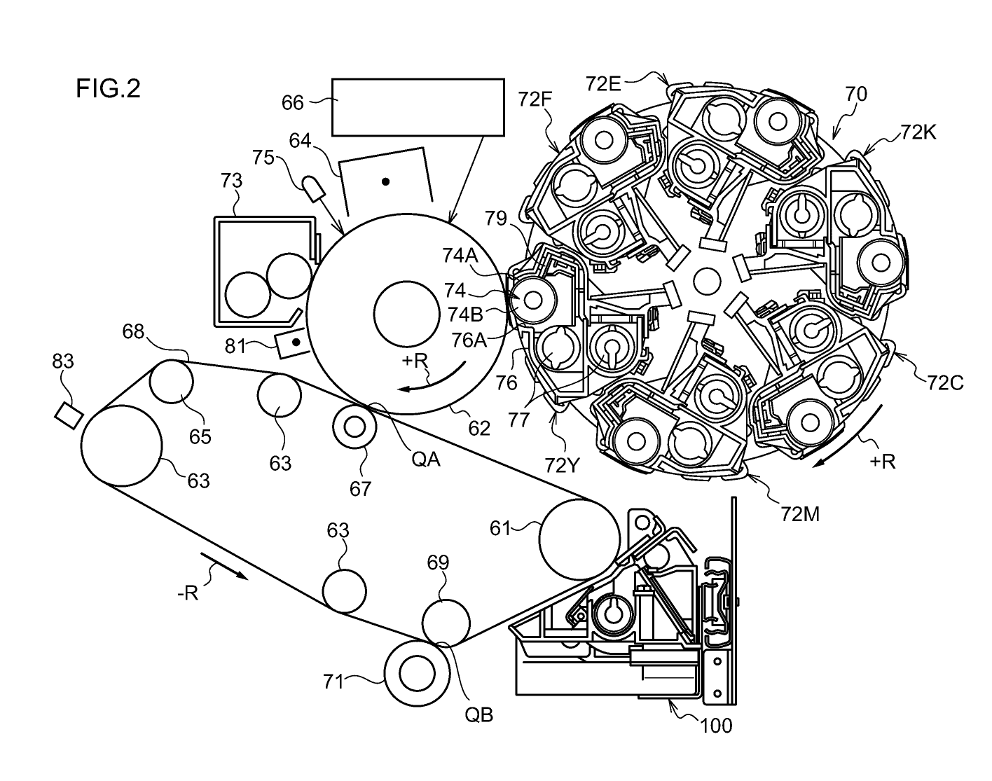

As shown in FIG. 2, the developing device 70 has developer units 72Y, 72M, 72C, 72K, 72E, 72F disposed in a row (in this sequence in the anticlockwise direction) along the peripheral direction of the developing device 70, corresponding to each of the toner colors yellow (Y), magenta (M), cyan (C), black (K), first spot color (E), second spot color (F), respectively. The developer units 72Y, 72M, 72C, 72K, 72E, 72F are disposed such that whichever of the developer unit 72Y, 72M, 72C, 72K, 72E or 72F is performing development processing is switched over to face the outer peripheral face of the photoreceptor 62 by rotating the developing device 70 through a central angle of 60° at a time using a motor (not shown in the drawings) that serves as a rotation section. Note that, since the developer units 72Y, 72M, 72C, 72K, 72E, 72F are each of a similar configuration, explanation will be given here of developer unit 72Y, and further explanation of the other developer units 72M, 72C, 72K, 72E, 72F omitted. Furthermore, when performing image forming with 4-colors Y, M, C, K, since the developer units 72E and 72F are not employed, the rotation angle from the developer unit 72K to the developer unit 72Y becomes 180°.

The developer unit 72Y has a case member 76 as the main body, and is filled with a developer (not shown in the drawings), formed from a toner and a carrier. The developer is supplied through a toner supply path (not shown in the drawings) from the toner cartridge 78Y (see FIG. 1) in the case member 76. A rectangular shaped opening 76A is formed in the case member 76 facing the outer peripheral face of the photoreceptor 62, and a developer roll 74 is provided at the opening 76A such that the outer peripheral face of the developer roll 74 faces the outer peripheral face of the photoreceptor 62. A plate shaped metering member 79 for regulating the thickness of developer is provided along the length direction of the opening 76A inside the case member 76 at a position in the vicinity of the opening 76A.

The developer roll 74 is configured including a rotatably provided circular cylindrical shaped developer sleeve 74A and a magnetic member 74B formed from plural magnetic poles fixed to the inside of the developer sleeve 74A. Configuration is made such that a developer layer is formed on the outer peripheral face of the developer sleeve 74A by forming a magnetic brush of developer (carrier) by rotating the developer sleeve 74A, and by regulating the thickness with the metering member 79. The developer layer on the outer peripheral face of the developer sleeve 74A is configured to a position facing the photoreceptor 62, and developing is performed by adhering toner according to the latent image (electrostatic latent image) formed on the outer peripheral face of the photoreceptor 62.

Two spiral shaped conveying rollers 77 are also rotatably provided next to each other inside the case member 76. The developer filled in the case member 76 is conveyed in a circulating manner along the axial direction of the developer roll 74 (the length direction of the developer unit 72Y) by rotating the two conveying rollers 77. Note that the 6 developer rolls 74 provided in the developer units 72Y, 72M, 72C, 72K, 72E, 72F are each disposed around the peripheral direction so as to be separated by a central angle of 60° from the adjacent developer roll 74. Configuration is made such that by switching over the developer unit 72, the next developer roll 74 faces the outer peripheral face of the photoreceptor 62.

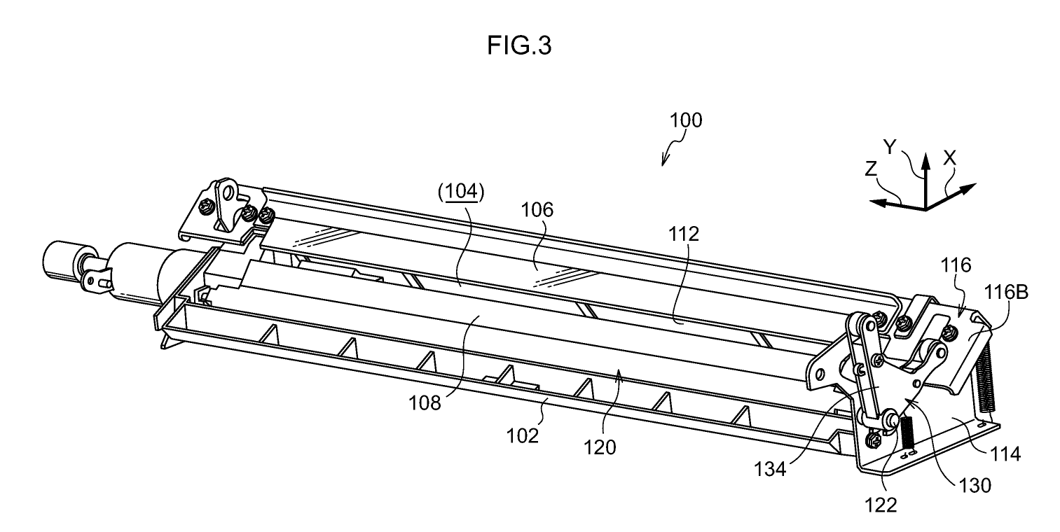

As shown in FIG. 3, the cleaning device 100 is configured including: a casing 102 formed with a rectangular shaped opening 104 disposed facing the intermediate transfer belt 68 (see FIG. 2); a cleaning blade 106 provided at the opening 104, making contact with the intermediate transfer belt 68, and recovering toner; and a seal member 108 provided at the opening 104 at a position on the opposite side to that of the cleaning blade 106, the seal member 108 contacting the intermediate transfer belt 68 and tightly sealing the gap between the casing 102 and the intermediate transfer belt 68. The cleaning blade 106 is attached to a plate shaped first moveable portion 116 that is moveable in a circular arc at an upper portion of the casing 102, and the seal member 108 is attached to a plate shaped second movable portion 120 that is moveable in a circular arc at a lower portion of the casing 102.

The cleaning device 100 also includes: a suction section, not shown in the drawings, (for example a suction fan and duct) that suctions in toner and the like remaining on the intermediate transfer belt 68 into the casing 102; a filter 112 provided inside the casing 102 and collecting together the dust, including toner; and a retraction mechanism 130 that moves the cleaning blade 106 and the seal member 108 between positions that make contact with the outer peripheral face of the intermediate transfer belt 68 and positions that are separated from the outer peripheral face of the intermediate transfer belt 68.

The retraction mechanism 130 is provided to side plates 114 that are attached to each end of the casing 102 along the arrow Z direction (the direction from the near side to the far side of the image forming apparatus 10 (see FIG. 1)). The retraction mechanism 130 has a link member 134 that moves in a circular arc about a support shaft 122, in time with movement of an eccentric cam (not shown in the drawings) that is rotated by a drive source. In the retraction mechanism 130, the second movable portion 120 is attached to the support shaft 122, such that the second movable portion 120 and the seal member 108 move due to rotation of the support shaft 122. Furthermore, in the retraction mechanism 130, the link member 134 moves the cleaning blade 106 by making contact with an end portion 116B of the first moveable portion 116.

Explanation now follows regarding combinations of a first process speed VA and a second process speed VB set in the control section 20.

In FIG. 2, a combination of a first process speed (VA) from charging the photoreceptor 62 to primary transfer, and a second process speed (VB) from primary transfer to secondary transfer, is set in advance in a control section 20 (see FIG. 1), according to the number of units employed from the developer units 72Y, 72M, 72C, 72K, 72E, 72F (4 or 6 in the present exemplary embodiment) and the thickness of the recording paper P.

More precisely, a first process is a process from starting to charge the photoreceptor 62 using the charging member 64, through the exposure process using the light-exposing device 66 and the developing process using the developing device 70, and ending with primary transfer using the primary transfer roll 67, and this process is repeated for the number of developer units 72 being used (the number of colors). The second process is from when the toner image of the last color has been primary transferred to the intermediate transfer belt 68, up to when these toner images have completed secondary transfer all at once onto the recording paper P using the secondary transfer roll 71. Since the first process is transfer of toner images from the photoreceptor 62 to the intermediate transfer belt 68, and the second process is transfer of toner images from the intermediate transfer belt 68 to the recording paper P, both the first process speed VA and the second process speed VB are settings for the movement speed of the intermediate transfer belt 68.

Furthermore, since the second process speed VB is the movement speed of the intermediate transfer belt 68 in the secondary transfer position QB, and this is equivalent to the conveying speed (fixing speed) of the recording paper P in the fixing device 80 (see FIG. 1), fundamentally the second process speed VB is never faster than the first process speed VA. Accordingly, the first process speed VA≧the second process speed VB. In the present exemplary embodiment, there are 4 ways of setting in the control section 20 for combinations of the first process speed VA and the second process speed VB: cases of VA>VB when image forming for 4-colors Y, M, C, K; cases of VA=VB when image forming for 4-colors Y, M, C, K; cases of VA>VB when image forming for 6-colors Y, M, C, K, E, F; and cases of VA=VB when image forming for 6-colors Y, M, C, K, E, F.

FIG. 4A is a schematic diagram showing toner image transfer states onto the intermediate transfer belt 68 over that passage of time when the first process speed VA>the second process speed VB in image forming of 4-colors Y, M, C, K. Note that below, the movement speed (rounding speed) of the intermediate transfer belt 68 when not decelerated is denoted V1, the movement speed of the intermediate transfer belt 68 when decelerated from movement speed V1 is denoted V2, the point in time when the Y toner image starts being primary transferred is denoted t0, the intermediate transfer belt 68 deceleration start point in time is denoted t1, the intermediate transfer belt 68 deceleration complete point in time is denoted t2, acceleration start point in time t3, and acceleration complete point in time t4, and the point in time when image forming on one sheet of the recording paper P is complete is denoted t5. The points in time t1, t2, t3, t4 and t5 take different values depending on the setting conditions for image forming, with a shorter separation on the horizontal axis in the drawings indicating a shorter duration in these conditions.

As shown in FIG. 4A, when the first process speed VA>the second process speed VB for VA=V1, the toner images of 4-colors Y, M, C, K are transferred in sequence and superimposed onto the intermediate transfer belt 68 between the point in time t0 and point in time t1. The color of the developer unit 72 is switched over during the interval between transfer of each color. Then the movement speed of the intermediate transfer belt 68 is decelerated from V1 to V2 from the point in time t1 to the point in time t2, until first process speed VA matches the second process speed VB (=V2). In the present invention, since the leading edge of the toner image of the 4^{th} color (shown as K in the drawing) arrives at the secondary transfer position QB (see FIG. 2) during the period of deceleration, the intermediate transfer belt 68 circulates one extra time.

Then, the toner images are secondary transferred all at once onto the recording paper P under conditions of movement speed V2, and a transfer remnant LT (shown by the double-dot broken line in the drawing) of the toner remains on the intermediate transfer belt 68. Since the movement speed of the intermediate transfer belt 68 can be freely varied while the transfer remnant LT is in place, the intermediate transfer belt 68 is accelerated during this time (from point in time t3 to point in time t4) from V2 to V1, to return to the original first process speed VA. The retraction mechanism 130 (see FIG. 3) of the cleaning device 100 is then operated, the cleaning blade 106 is contacted against the outer peripheral face of the intermediate transfer belt 68, and the transfer remnant (shown by the double-dot broken line LT in the drawing) on the intermediate transfer belt 68 is removed with the cleaning blade 106 (shown by intermittent line CL in the drawing). After the transfer remnant LT has been removed, the retraction mechanism 130 (see FIG. 3) is operated in the opposite direction, separating the cleaning blade 106 from the outer peripheral face of the intermediate transfer belt 68. The point in time here is t5, and image forming processing for 1 sheet of the recording paper P is completed. Note that the image forming processing of the next sheet of recording paper P is performed similarly from point in time t5 onwards.

Furthermore, FIG. 4B shows a schematic diagram of the toner image transfer states onto the intermediate transfer belt 68 over that passage of time when image forming with 4-colors Y, M, C, K with first process speed VA=second process speed VB.

As shown in FIG. 4B, when the first process speed VA=second process speed VB for VA=VB=V1, the toner images of 4-colors Y, M, C, K are transferred in sequence and superimposed onto the intermediate transfer belt 68 between the point in time t0 and point in time t5. The color of the developer unit 72 is switched over during the interval between transfer of each color. Then after the trailing edge of the K toner image has been primary transferred onto the intermediate transfer belt 68, the toner images are secondary transfer all at once onto the recording paper P under conditions of movement speed V1, and transfer remnant toner on the intermediate transfer belt 68 is removed by the cleaning device 100. The cleaning blade 106 is then separated from the outer peripheral face of the intermediate transfer belt 68, completing image forming processing for 1 sheet of the recording paper P. Note that the image forming processing of the next sheet of recording paper P is performed similarly from point in time t5 onwards.

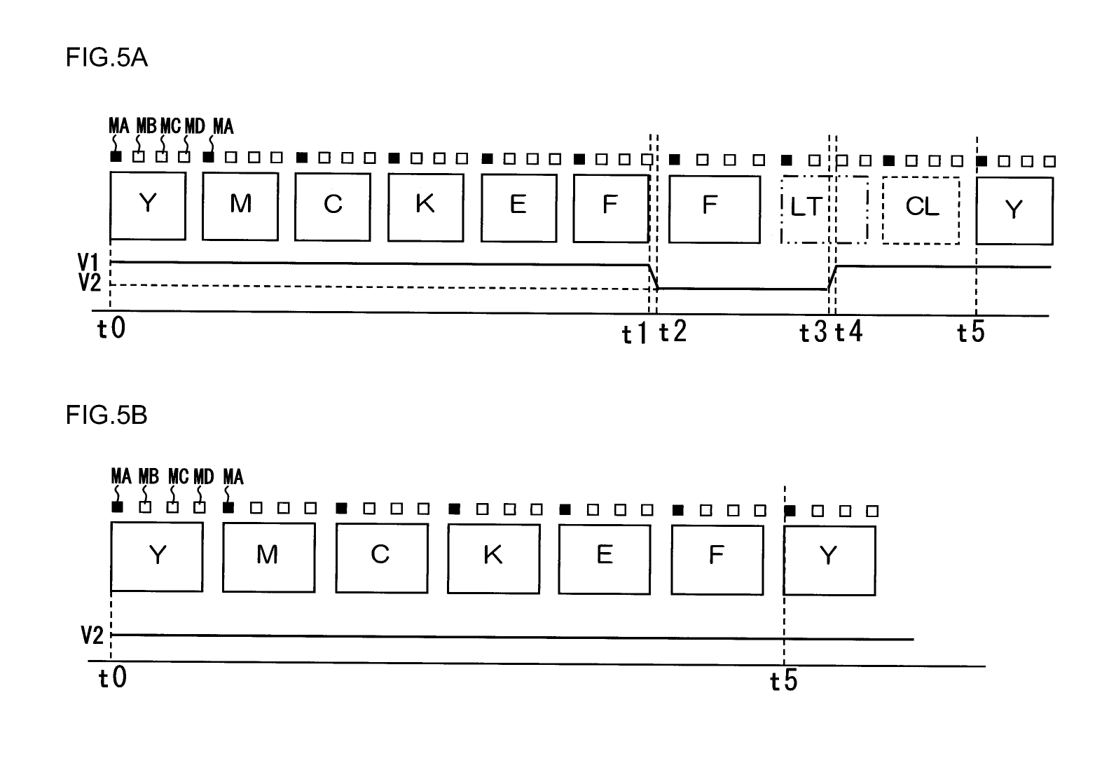

FIG. 5A shows a schematic diagram of the toner image transfer states onto the intermediate transfer belt 68 over that passage of time for image forming of 6-colors Y, M, C, K, E, F when first process speed VA>second process speed VB.

As shown in FIG. 5A, when the first process speed VA>the second process speed VB for VA=V1, the toner images of 6-colors Y, M, C, K, E, F are transferred in sequence and superimposed onto the intermediate transfer belt 68 between the point in time t0 and point in time t1. The color of the developer unit 72 is switched over during the interval between transfer of each color. Then the movement speed of the intermediate transfer belt 68 is decelerated from V1 to V2 from the point in time t1 to the point in time t2, until the first process speed VA matches the second process speed VB (=V2). In the present invention, since the leading edge of the toner image of the 6^{th} color (shown as F in the drawing) arrives at the secondary transfer position QB (see FIG. 2) during the period of deceleration, the intermediate transfer belt 68 circulates one extra time.

Then, the toner images are secondary transferred all at once onto the recording paper P under conditions of movement speed V2, and transfer remnant LT of the toner remains on the intermediate transfer belt 68. From the point in time t3 to the point in time t4, the movement speed of the intermediate transfer belt 68 is accelerated from V2 to V1, to return to the original first process speed VA. The retraction mechanism 130 (see FIG. 3) of the cleaning device 100 is then operated, the cleaning blade 106 is contacted against the outer peripheral face of the intermediate transfer belt 68, the transfer remnant LT on the intermediate transfer belt 68 is removed with the cleaning blade 106 (shown by intermittent line CL in the drawing). After the transfer remnant LT has been removed, the retraction mechanism 130 (see FIG. 3) is operated in the opposite direction, separating the cleaning blade 106 from the outer peripheral face of the intermediate transfer belt 68. The point in time here is t5, and image forming processing for 1 sheet of the recording paper P is completed. Note that the image forming processing of the next sheet of recording paper P is performed similarly from point in time t5 onwards.

Furthermore, FIG. 5B shows a schematic diagram of the toner image transfer states onto the intermediate transfer belt 68 over that passage of time when image forming with 6-colors Y, M, C, K, E, F with the first process speed VA=the second process speed VB.

As shown in FIG. 5B, when the first process speed VA=the second process speed VB for VA=VB=V1, the toner images of 6-colors Y, M, C, K, E, F are transferred in sequence and superimposed onto the intermediate transfer belt 68 between the point in time t0 and point in time t5. The color of the developer unit 72 is switched over during the interval between transfer of each color. Then after the trailing edge of the F toner image has been primary transferred onto the intermediate transfer belt 68, the toner images are secondary transferred all at once onto the recording paper P under conditions of movement speed V1, and transfer remnant toner on the intermediate transfer belt 68 is removed by the cleaning device 100. The cleaning blade 106 is then separated from the outer peripheral face of the intermediate transfer belt 68, completing image forming processing for 1 sheet of the recording paper P. Note that the image forming processing of the next sheet of recording paper P is performed similarly from point in time t5 onwards.

In the control section 20 (see FIG. 1), the four combinations of first process speed VA and second process speed VB are selected according to the paper thickness of the recording paper P. As an example, when the paper thickness for 4 color image forming is 128 gsm (grams per square meter) or less, settings are: first process speed VA=220 mm/s and second process speed VB=220 mm/s.

Other settings are: when paper thickness of the recording paper P for 4 color image forming is 129 gsm or greater, VA=160 mm/s, VB=160 mm/s; when paper thickness of the recording paper P for 6 color image forming is 128 gsm or less, VA=220 mm/s, VB=220 mm/s; and when the paper thickness of the recording paper P for 6 color image forming is 129 gsm or greater, VA=160 mm/s and VB=160 mm/s. Note that the above values are setting values for a peripheral length of the intermediate transfer belt 68=527.8 mm, the employed paper size is A3 portrait (420 mm), and the distance from primary transfer position QA to secondary transfer position QB of the intermediate transfer belt 68 is 311.1 mm (towards the downstream side in the movement direction).

Explanation now follows regarding operation of the first exemplary embodiment.

As shown in FIG. 1, as an example, when the number of operating developer units 72 (see FIG. 2) employed is 4 colors, and the thickness of the recording paper P is 128 gsm or below, the control section 20 selects and sets the combination of the first process speed VA=220 mm/s and the second process speed VB=220 mm/s. Then, when the image forming apparatus 10 is operated, image data for each of the colors yellow (Y), magenta (M), cyan (C) and black (K) is sequentially output to the light-exposing device 66 from an image processing apparatus (not shown in the drawings) or from outside. The developing device 70 rotates such that developer unit 72Y (see FIG. 2) is facing the outer peripheral face of the photoreceptor 62 and held in that position. Note the cleaning blade 106 and the seal member 108 (see FIG. 3) of the cleaning device 100 are kept separated from the outer peripheral face of the intermediate transfer belt 68 by operation of the retraction mechanism 130 (see FIG. 3) until toner images for all of the colors have been superimposed (primary) transferred to the intermediate transfer belt 68 and also secondary transferred onto the recording paper P.

Then, light emitted from the light-exposing device 66 according to the image data is used to expose the outer peripheral face (surface) of the photoreceptor 62 that has been charged by the charging member 64, and an electrostatic latent image is formed on the surface of the photoreceptor 62 corresponding to image data for yellow. The electrostatic latent image formed on the surface of the photoreceptor 62 is developed as a yellow toner image by the developer unit 72Y. Then the yellow toner image on the surface of the photoreceptor 62 is primary transfer onto the intermediate transfer belt 68 by the primary transfer roll 67. When this is being performed the movement speed of the intermediate transfer belt 68 is the first process speed VA=220 mm/s.

Then, as shown in FIG. 2, the developing device 70 is rotated by 60° in the arrow +R direction in order to make the developer unit 72M face towards the photoreceptor 62. Then each of the processes of charging, exposing, developing are performed, and a magenta toner image on the surface of the photoreceptor 62 is transferred by the primary transfer roll 67 onto the intermediate transfer belt 68 on top of the yellow toner image. Cyan (C) and black (K) toner images are similarly superimposed and transferred in sequence onto the intermediate transfer belt 68.

As shown in FIG. 1, the recording paper P that has been fed out from the paper housing section 12 and arrived along the conveying path 28 is conveyed into the secondary transfer position QB at a timing matched by the positioning rolls 38 to the superimposed-transferred toner images on the intermediate transfer belt 68. The superimposed-transferred toner image on the intermediate transfer belt 68 is secondary transferred by the secondary transfer roll 71 onto the recording paper P that has been conveyed into the secondary transfer position QB. When this is being performed the movement speed of the intermediate transfer belt 68 is the second process speed VB=220 mm/s. After secondary transfer, the cleaning blade 106 and the seal member 108 of the cleaning device 100 are brought into contact with the outer peripheral face of the intermediate transfer belt 68 by operation of the retraction mechanism 130 (see FIG. 3). The toner T adhered to the outer peripheral face of the intermediate transfer belt 68 is removed by the cleaning blade 106.

The recording paper P onto which the toner image has been transferred is conveyed towards the fixing device 80 in the arrow A direction (towards the right in the drawing). In the fixing device 80, the toner image is then fixed to the recording paper P by application of heat and pressure to the toner image by the heating roll 82 and the press roll 84. The toner image fixed recording paper P is then, for example, discharged to the discharge section 15.

Note that in order to form images on both sides of the recording paper P, after image fixing on the front face with the fixing device 80, and the leading edge and the trailing edge of the recording paper P are exchanged by conveying the recording paper P in the arrow −V direction into the reversing section 33 and feeding it back out in the arrow +V direction. The recording paper P is then conveyed in the arrow B direction (towards the left in the drawing) along the double-sided conveying path 29, and fed back into the conveying path 28 where image forming and fixing are performed on the reverse face of the recording paper P (when this is being performed the cleaning blade 106 and the seal member 108 adopt a retracted state). Then after fixing, the cleaning blade 106 and the seal member 108 are brought into contact with the outer peripheral face of the intermediate transfer belt 68 by operation of the retraction mechanism 130. The toner T adhered to the outer peripheral face of the intermediate transfer belt 68 is removed by the cleaning blade 106.

Table 1 shows setting values of the first process speed VA and the second process speed VB, set for combinations of number of colors of developer units 72 employed and paper thickness of the recording paper P, against the duration required for image forming of one sheet of recording paper P under these setting conditions. Note that in Table 1, results are also shown when a combination of a first process speed VA of 267.3 mm/s and second process speeds VB of 220 mm/s and 160 mm/s are selected, as comparative examples to the present exemplary embodiment.

TABLE 1

| NUMBER OF | | | | | TIME FOR |
|---|---|---|---|---|---|
| IMAGE | PAPER | | FIRST | SECOND | IMAGE |
| FORMING | THICKNESS | | PROCESS | PROCESS | FORMING |
| COLORS | (gsm) | EXAMPLE | SPEED (mm/s) | SPEED (mm/s) | PER SHEET (s) |
| 4 COLORS | 128 OR LESS | COMPARATIVE | 267.3 | 220 | 14.5 |
| | | EXAMPLE | | | |
| | | PRESENT | 220 | 220 | 9.6 |
| | | EXEMPLARY | | | |
| | | EMBODIMENT | | | |
| | 129 OR MORE | COMPARATIVE | 267.3 | 160 | 15.9 |
| | | EXAMPLE | | | |
| | | PRESENT | 160 | 160 | 13.2 |
| | | EXEMPLARY | | | |
| | | EMBODIMENT | | | |
| 6 COLORS | 128 OR LESS | COMPARATIVE | 267.3 | 220 | 18.4 |
| | | EXAMPLE | | | |
| | | PRESENT | 220 | 220 | 14.4 |
| | | EXEMPLARY | | | |
| | | EMBODIMENT | | | |
| | 129 OR MORE | COMPARATIVE | 267.3 | 160 | 19.9 |
| | | EXAMPLE | | | |
| | | PRESENT | 160 | 160 | 19.8 |
| | | EXEMPLARY | | | |
| | | EMBODIMENT | | | |

It can be ascertained from Table 1 that the image forming duration per sheet of the recording paper P in the present exemplary embodiment is shorter than the comparative examples under all conditions. Namely, it can be ascertained that the present exemplary embodiment suppresses a reduction in productivity when image forming in comparison to the comparative examples.

Taking as a computation example the image forming duration (referred to as Δt) per sheet of recording paper P in Table 1 when the first process speed VA=the second process speed VB, for example, when the number of image forming colors is 4, the recording paper thickness is 128 gsm or less, VA=220 mm/s, and VB=220 mm/s, then Δt is derived=(peripheral length of intermediate transfer belt 68 (527.8 mm)×number of colors (4))/220≈9.6 seconds (see FIG. 4B).

However, as shown in Table 1, taking as a computation example the image forming duration (referred to as Δt) per sheet of recording paper P in Table 1 when the first process speed VA>the second process speed VB, for example, when the number of image forming colors is 6, the recording paper thickness is 129 gsm or greater, then settings are VA=267.3 mm/s, VB=220 mm/s. The duration required for acceleration or deceleration of the intermediate transfer belt 68 is 0.14 seconds. Then, referring to FIG. 5A, a duration between image forming start time t0 to deceleration start time t1 is duration Δt1=(527.8 mm (peripheral length)×5 (colors)+420 mm (length of one colors worth))/267.3≈11.4 seconds, so as to give a duration from deceleration start time t1 to deceleration finish time t2 of duration Δt2=0.14 seconds.

The average speed during deceleration is (267.3+220)/2=243.65 mm/s, and the movement distance of the intermediate transfer belt 68 during deceleration is 0.14 s×243.65 mm/s=34.111 mm. A length from the primary transfer position QA to the secondary transfer position QB=311.1 mm is employed, and a duration from deceleration finish time t2 to acceleration start time t3 is duration Δt3=(527.8−34.111+311.1)/220≈3.66 s. The duration from acceleration start time t3 to acceleration finish time t4 duration Δt4=0.14 s.

Furthermore, with reference to FIG. 5A, the duration from acceleration finish time t4 to image forming finish time t5 of duration Δt5=(527.8×3−420−311.1−34.111)/267.3≈3.06. From this, the image forming duration Δt per sheet of recording paper P is derived when VA=267.3 mm/s, VB=220 mm/s=Δt1+Δt2+Δt3+Δt4+Δt5=11.4+0.14+3.66+0.14+3.06≈18.4 seconds.

Explanation now follows regarding an example of an image forming apparatus according to a second exemplary embodiment of the present invention. Note that components that are fundamentally the same as those of the above first exemplary embodiment are allocated the same reference numerals as in the first exemplary embodiment and further explanation is omitted.

In a control section 20 of the second exemplary embodiment (see FIG. 1), configuration is made such that pre-selection is made of a combination of the first process speed VA and the second process speed VB according to the number of developer units 72 employed (see FIG. 2) (for example 4 or 6) and the length of the recording paper P. As an example in the present exemplary embodiment, when the conveying direction length of the recording paper P for 6-color image forming is 488 mm, first process speed VA=second process speed VB=220 mm/s is set. These values are setting values for an intermediate transfer belt 68 (see FIG. 2) of peripheral length=527.8 mm, employed paper thickness 128 gsm or less, length from the primary transfer position QA to the secondary transfer position QB of the intermediate transfer belt 68=311.1 mm (towards the downstream side in the movement direction). In the present exemplary embodiment, first process speed VA=second process speed VB=220 mm/s is set also when the conveying direction length of the recording paper P is 420 mm (A3 size).

Explanation now follows regarding operation of the second exemplary embodiment.

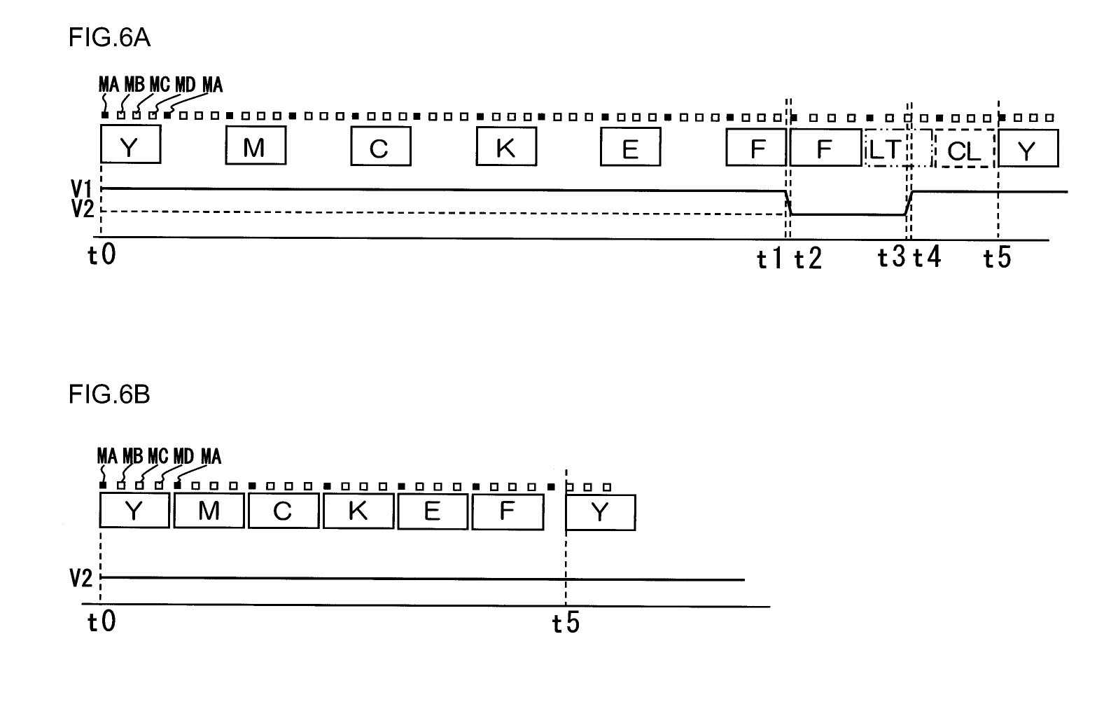

First, explanation follows regarding a comparative example to the present exemplary embodiment. FIG. 6A shows, as a comparative example, a schematic diagram of the transfer state of toner images with the passage of time onto the intermediate transfer belt 68 for a recording paper P length of 488 mm, image forming of 6-colors Y, M, C, K, E, F, and the first process speed VA>the second process speed VB. As an example, for the comparative example settings are first process speed VA=267.3 mm/s, second process speed VB=220 mm/s.

As shown in FIG. 6A, in the comparative example, toner images of the 6-colors Y, M, C, K, E, F are transferred and superimposed in sequence onto the intermediate transfer belt 68 in the interval from the point in time t0 to the point in time t1. The color of the developer unit 72 is switched over during the interval between transfer of each color. Then the movement speed of the intermediate transfer belt 68 is decelerated from V1 to V2 from the point in time t1 to the point in time t2, until first process speed VA matches the second process speed VB (=V2). Since the leading edge of the toner image of the 6^{th} color (shown as F in the drawing) arrives at the secondary transfer position QB (see FIG. 2) during the period of deceleration, the intermediate transfer belt 68 circulates one extra time.

Then, the toner images are secondary transferred all at once onto the recording paper P under conditions of movement speed V2, and transfer remnant LT of toner remains on the intermediate transfer belt 68. The intermediate transfer belt 68 is accelerated from the point in time t3 to the point in time t4 from V2 to V1, returning to the original first process speed VA. The retraction mechanism 130 (see FIG. 3) of the cleaning device 100 is then operated, the cleaning blade 106 is contacted against the outer peripheral face of the intermediate transfer belt 68, the transfer remnant LT on the intermediate transfer belt 68 is removed with the cleaning blade 106 (shown by intermittent line CL in the drawing). After the transfer remnant LT has been removed, the retraction mechanism 130 (see FIG. 3) is operated in the opposite direction, separating the cleaning blade 106 from the outer peripheral face of the intermediate transfer belt 68. The point in time here is t5, and the image forming processing for 1 sheet of the recording paper P is completed. Note that the image forming processing of the next sheet of recording paper P is performed similarly from point in time t5 onwards.

In the comparative examples, in the duration from the point in time t0 to the point in time t1, since the intermediate transfer belt 68 is moving at a higher speed than in the present exemplary embodiment, the movement duration for the portions of time in which the toner images are not being formed on the intermediate transfer belt 68 are shorter, and rotational movement of the developer unit 72 (see FIG. 2) cannot keep up. Therefore, in the comparative example, the intermediate transfer belt 68 is rotated one extra time, and the interval between toner images of each of the colors is made wider.

However, in the present exemplary embodiment, as an example, when the number of developer units 72 employed (see FIG. 2) is 6 colors, and the recording paper P length is 488 mm, the control section 20 selects and sets the combination of first process speed VA=second process speed VB=220 mm/s. Then, when the image forming apparatus 10 of FIG. 1 is operated, image data for each of the colors yellow (Y), magenta (M), cyan (C), black (K), first spot color (E), second spot color (F) is sequentially output to the light-exposing device 66 from an image processing apparatus (not shown in the drawings) or from outside. The developing device 70 rotates such that developer unit 72Y (see FIG. 2) is made to face the outer peripheral face of the photoreceptor 62 and held in that position. Note the cleaning blade 106 and the seal member 108 (see FIG. 3) of the cleaning device 100 are kept separated from the outer peripheral face of the intermediate transfer belt 68 by operation of the retraction mechanism 130 (see FIG. 3) until toner images for all of the colors have been superimposed (primary) transferred to the intermediate transfer belt 68 and also secondary transferred onto the recording paper P.

Then, light emitted from the light-exposing device 66 according to the image data is used to expose the outer peripheral face (surface) of the photoreceptor 62 that has been charged by the charging member 64, and an electrostatic latent image is formed on the surface of the photoreceptor 62 corresponding to image data for yellow. The electrostatic latent image formed on the surface of the photoreceptor 62 is developed as a yellow toner image by the developer unit 72Y. Then the yellow toner image on the surface of the photoreceptor 62 is primary transfer onto the intermediate transfer belt 68 by the primary transfer roll 67. When this is being performed the movement speed of the intermediate transfer belt 68 is the first process speed VA=220 mm/s.

Then, as shown in FIG. 2, the developing device 70 is rotated by 60° in the arrow +R direction to make the developer unit 72M face towards the photoreceptor 62. Then each of the processes of charging, exposing, developing are performed, and a magenta toner image on the surface of the photoreceptor 62 is transferred the primary transfer roll 67 onto the intermediate transfer belt 68 on top of the yellow toner image. Cyan (C), black (K), first spot color (E) and second spot color (F) toner images are similarly superimposed and transferred in sequence onto the intermediate transfer belt 68.

In the present exemplary embodiment, the first process speed VA (220 mm/s) is set lower than the first process speed VA of the comparative example (267.3 mm/s).

Accordingly, the rotational movement of the developing device 70 (the plural developer units 72) is able to keep up between the toner images of each color, it is not necessary to make the intermediate transfer belt 68 circulate one extra time, and the toner image interval is narrower than the comparative example.

However, as shown in FIG. 1, the recording paper P that has been fed out from the paper housing section 12 and arrived along the conveying path 28 is conveyed into the secondary transfer position QB at a timing matched by the positioning rolls 38 to the superimposed-transferred toner images on the intermediate transfer belt 68. The superimposed-transferred toner images on the intermediate transfer belt 68 are secondary transferred by the secondary transfer roll 71 onto the recording paper P that has been conveyed into the secondary transfer position QB. When this is being performed the movement speed of the intermediate transfer belt 68 is the second process speed VB=220 mm/s.

Then, after secondary transfer of the toner images onto the recording paper P, the cleaning blade 106 and the seal member 108 of the cleaning device 100 are brought into contact with the outer peripheral face of the intermediate transfer belt 68 by operation of the retraction mechanism 130 (see FIG. 3). The toner LT adhered to the outer peripheral face of the intermediate transfer belt 68 is removed by the cleaning blade 106.

Then the recording paper P onto which the toner images have secondary transferred is conveyed towards the fixing device 80 in the arrow A direction (towards the right in the drawing). In the fixing device 80, the toner image is then fixed to the recording paper P by application of heat and pressure to the toner image by the heating roll 82 and the press roll 84. The toner image fixed recording paper P is then, for example, discharged to the discharge section 15.

Table 2 shows setting values of the first process speed VA and the second process speed VB, set for combinations of number of colors of developer unit 72 employed and recording paper P length, against the duration required for image forming of one sheet of recording paper P under these setting conditions.

TABLE 2

| NUMBER OF | | | | | TIME FOR |
|---|---|---|---|---|---|
| IMAGE | | | FIRST | SECOND | IMAGE |
| FORMING | PAPER | | PROCESS | PROCESS | FORMING |
| COLORS | LENGTH (mm) | SUBJECT | SPEED (mm/s) | SPEED (mm/s) | PER SHEET (s) |
| 4 COLORS | 420 (A3) | COMPARATIVE | 267.3 | 220 | 14.5 |
| | | EXAMPLE | | | |
| | | PRESENT | 220 | 220 | 9.6 |
| | | EXEMPLARY | | | |
| | | EMBODIMENT | | | |
| | 488 | COMPARATIVE | 267.3 | 220 | 20.4 |
| | | EXAMPLE | | | |
| | | PRESENT | 220 | 220 | 10.2 |
| | | EXEMPLARY | | | |
| | | EMBODIMENT | | | |
| 6 COLORS | 420 (A3) | COMPARATIVE | 267.3 | 220 | 18.4 |
| | | EXAMPLE | | | |
| | | PRESENT | 220 | 220 | 14.4 |
| | | EXEMPLARY | | | |
| | | EMBODIMENT | | | |
| | 488 | COMPARATIVE | 267.3 | 220 | 28.3 |
| | | EXAMPLE | | | |
| | | PRESENT | 220 | 220 | 15.0 |
| | | EXEMPLARY | | | |
| | | EMBODIMENT | | | |

It can be ascertained from Table 2 that even when the recording paper P length is from 420 mm to 488 mm, by selecting a combination of first process speed VA and second process speed VB according to the present exemplary embodiment, and particularly by optimizing the first process speed VA, the image forming duration per sheet of the recording paper P in the present exemplary embodiment is made shorter. Namely, it can be ascertained that the image forming apparatus 10 of the present exemplary embodiment suppresses a reduction in productivity when image forming in comparison to the comparative examples.

The present invention is not limited to the above exemplary embodiments.

For example, the developing device 70 may be configured not only with 6-color developing units are 4 colors or 6 colors are employed, such that image forming is performed employing all developing units or only a portion of developing units in a developing device having a plural number of developing units other than 4 colors or 6 colors. The combinations of first process speed VA and second process speed VB may also be set according to the quality of the paper, such as coated paper or non-coated paper, or set according to the degree of glossiness required of the toner images after fixing.

The present invention is not limited to the above exemplary embodiment only but can be varied, modified or improved in various other ways.

The foregoing description of the embodiments of the present invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to are suited to the particular use contemplated. It is intended that the scope of the invention be defined by the following claims and their equivalents.

What is claimed is:

1. An image forming apparatus comprising:
a latent image holding body that holds a latent image;
a charging section that charges a surface of the image holding body;
a light-exposing section that light-exposes the surface of the latent image holding body that has been charged by the charging section and forms a latent image;
a plurality of developing units that are made to face the latent image holding body and develop the latent image on the latent image holding body with a developer to form a developer image;
a transfer-receiving member onto which developer images are transferred and superimposed in sequence by switching over the plurality of developing units;
a primary transfer section that primary transfers the developer image on the latent image holding body onto the transfer-receiving member;
a secondary transfer section that secondary transfers the developer image on the transfer-receiving member onto a recording medium; and
a selection section that selects a combination of a first process speed from charging the latent image holding body to the primary transfer and a second process speed from the primary transfer to the secondary transfer according to the number of developing units employed.

2. The image forming apparatus of claim 1, wherein the selection section changes the first process speed according to the number of developing units employed and a length of the recording medium.

3. The image forming apparatus of claim 1, wherein the selection section changes the first process speed according to the number of developing units employed and the thickness of the recording medium.
